(19) United States
(12) Patent Application Publication
(10) Pub. No.: US 2016/0017263 A1
(43) Pub. Date: Jan. 21, 2016

(54) WET CLEANING OF A CHAMBER COMPONENT

(71) Applicant: APPLIED MATERIALS, INC., Santa Clara, CA (US)

(72) Inventors: Ren-Guan DUAN, Fremont, CA (US); Juan Carlos ROCHA-ALVAREZ, San Carlos, CA (US); Sanjeev BALUJA, Campbell, CA (US); Daemian RAJ, Fremont, CA (US); Inna TUREVSKY, Santa Clara, CA (US)

(21) Appl. No.: 14/650,565

(22) PCT Filed: Jan. 21, 2014
(86) PCT No.: PCT/US2014/012296

§ 371 Date: Jun. 8, 2015

Related U.S. Application Data
(60) Provisional application No. 61/783,521, filed on Mar. 14, 2013.

(51) Int. Cl. C11D 11/00; C11D 7/10; B08B 3/10; C11D 7/08; B08B 3/08; B08B 3/12

(52) U.S. Cl. CPC C11D 11/007; B08B 3/08; B08B 3/12; B08B 3/10; C11D 7/08; C11D 7/10; C11D 11/0041

(57) ABSTRACT

Embodiments of the invention generally provide methods for cleaning a UV processing chamber component. In one embodiment, a method for cleaning a UV processing chamber component includes soaking the chamber component having a SiCO residue formed thereon in a cleaning solution for about 1 to 10 minutes. The cleaning solution comprises about 5% by weight to about 60% weight of NH₄F and about 0.5% by weight to about 10% by weight of HF. The method also includes polishing the chamber component. In another embodiment, a method of cleaning a processing chamber component fabricated from quartz includes soaking the chamber component having a SiCO residue formed thereon in a cleaning solution comprising about 36% by weight of NH₄F and about by weight of HF for about 3 minutes. The method also includes applying an ultrasonic power to the cleaning solution, and mechanically polishing the chamber component.

### BACKGROUND OF THE INVENTION

1. Field of the Invention

Embodiments of the present invention generally relate to methods of cleaning a chamber component for use in an ultra violet (UV) processing chamber.

2. Description of the Related Art

The fabrication of microelectronics or integrated circuit devices typically involves a complicated process sequence requiring hundreds of individual steps performed on semiconductive, dielectric and conductive substrates in a variety of processing chambers. For example, a processing chamber such as a UV chamber is used for pore sealing a plasma-deposited thin film by using UV curing. UV light passes from a UV source to the chamber through a showerhead (typically fabricated from quartz). Over time, residues formed on the chamber components significantly reduce the UV transmittance and increase particulate contamination in the chamber. Replacing chamber components significantly increases costs. Thus, there is a need in the art for an improved method of cleaning residues on the chamber components and increasing UV efficiency.

### SUMMARY OF THE INVENTION

Embodiments of the invention generally provide methods for removing silicon carbide oxide (SiCO) residues on exposed surfaces of the chamber components (such as showerheads, process kit rings, shields, liners, optical components, and substrate support) disposed within a UV processing chamber. Particularly, the chamber components are efficiently cleaned with an aqueous cleaning solution comprising ammonium fluoride (NH₄F) and hydrofluoric acid (HF).

In one embodiment, a method for cleaning a UV processing chamber component is provided. The method includes soaking the chamber component having a SiCO residue formed thereon in an aqueous cleaning solution for about 1 to about 10 minutes. The cleaning solution comprises about 5% by weight to about 60% by weight NH₄F and about 0.5% by weight to about 10% by weight HF. The method also includes polishing the chamber component.

In another embodiment, a method of cleaning a processing chamber component fabricated from quartz is provided. The method includes soaking the chamber component having a SiCO residue formed thereon in an aqueous cleaning solution comprising about 36% by weight NH₄F and about 5% by weight HF for about 3 minutes. The method also includes applying an ultrasonic power to the cleaning solution, and mechanically polishing the chamber component.

### BRIEF DESCRIPTION OF THE DRAWINGS

So that the manner in which the above-recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a schematic sectional view of a processing chamber according to one embodiment;

FIG. 2 is a schematic sectional view of a cleaning container; and

FIG. 3 is a flow diagram of a method of cleaning a chamber component.

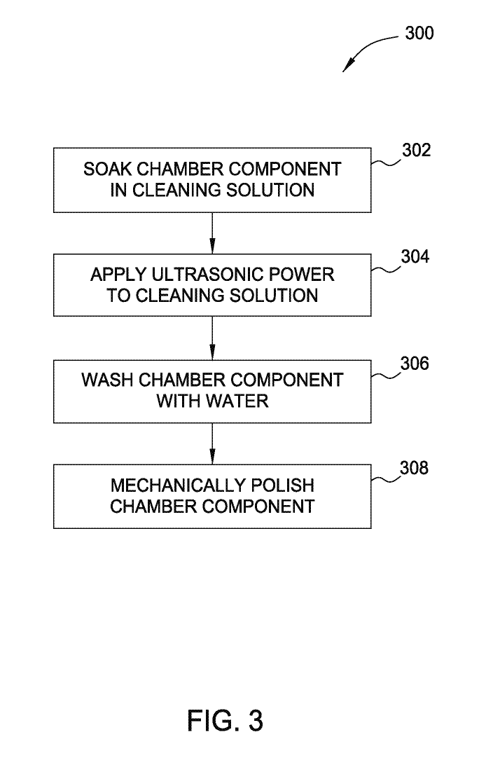

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

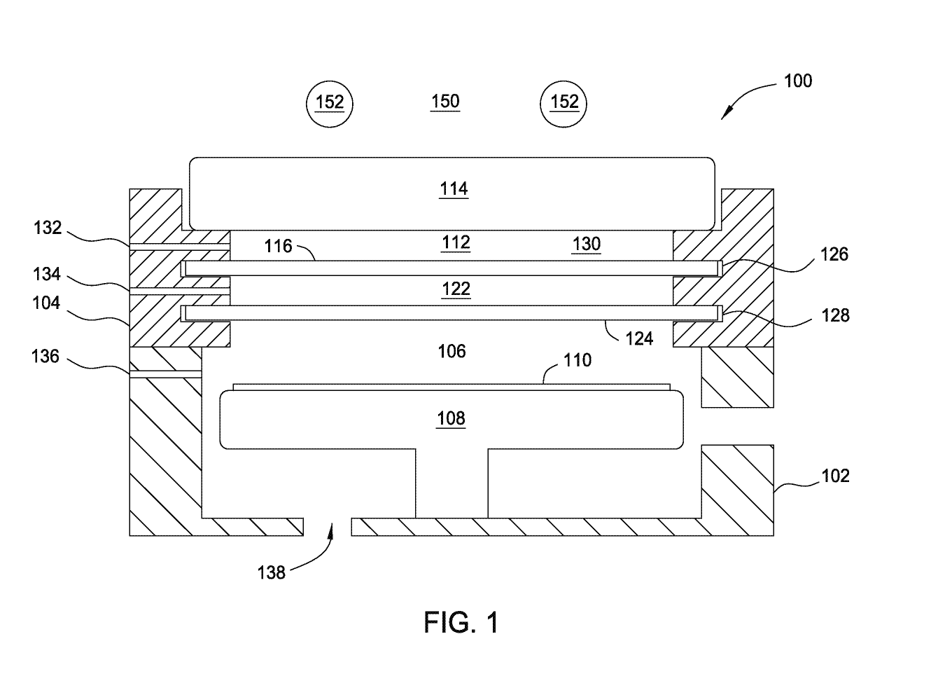

FIG. 1 is a schematic sectional view of a processing chamber 100 according to one embodiment. The processing chamber 100 is configured to process a substrate using UV energy, one or more processing gases, and remotely generated plasma.

The processing chamber 100 includes a chamber body 102 and a chamber lid 104 disposed over the chamber body 102. The chamber body 102 and the chamber lid 104 form an inner volume 106. The substrate support 108 receives and supports a substrate 110 thereon for processing.

A first UV transparent gas distribution showerhead 116 is hung in the inner volume 106 through a central opening 112 of the chamber lid 104 by an upper and a lower clamping member (not shown). The UV transparent gas distribution showerhead 116 is positioned facing the substrate support 108 to distribute one or more processing gases across a distribution volume 122 which is below the first UV transparent gas distribution showerhead 116. A second UV transparent showerhead 124 is hung in the inner volume 106 through the central opening 112 of the chamber lid 104 below the first UV transparent gas distribution showerhead 116. Each of the UV transparent gas distribution showerheads 116, 124 is disposed in a recess formed in the chamber lid 104. A first recess 126 is an annular recess around an internal surface of the chamber lid 104, and the first UV transparent gas distribution showerhead 116 fits into the first recess 126. Likewise, a second recess 128 receives the second UV transparent gas distribution showerhead 124.

A UV transparent window 114 is disposed above the first UV transparent gas distribution showerhead 116. The UV transparent window 114 is positioned above the first UV transparent gas distribution showerhead 116 forming a gas volume 130 between the UV transparent window 114 and the first UV transparent gas distribution showerhead 116. The UV transparent window 114 may be secured to the chamber lid 104 by any convenient means, such as clamps, screws, or bolts.

The UV transparent window 114 and the first and second UV transparent gas distribution showerheads 116, 124 are at least partially transparent to thermal energy within the UV wavelengths. The UV transparent window 114 and the first and second UV transparent gas distribution showerheads 116, 124 may be fabricated from quartz or another UV transparent material, such as sapphire, calcium fluoride (CaF₂), magnesium fluoride (MgF₂), aluminum oxynitride (AlON), yttrium oxide (Y₂O₃), a silicon oxynitride material, or other suitable transparent material.

A UV source 150 is disposed above the UV transparent window 114. The UV source 150 is configured to generate UV energy and project the UV energy towards the substrate support 108 through the UV transparent window 114, the first UV transparent gas distribution showerhead 116, and the second UV transparent gas distribution showerhead 124. A cover (not shown) may be disposed above the UV source 150. In one embodiment, the cover may be shaped to assist projection of the UV energy from the UV source 150 towards the substrate support 108.

In one embodiment, the UV source 150 includes one or more UV lights 152 to generate UV radiation. More detailed descriptions of suitable UV sources can be found in U.S. Pat. No. 7,777,198, and United States Patent Publication 2006/0249175.

The processing chamber 100 includes flow channels configured to supply one or more processing gases across the substrate support 108 to process a substrate 110 disposed thereon. A first flow channel 132 provides a flow pathway for gas to enter the gas volume 130 and to be exposed to UV radiation from the UV source 150. The gas from the gas volume 130 may flow through the first UV transparent gas distribution showerhead 116 into the distribution volume 122. A second flow channel 134 provides a flow pathway for gas to enter the distribution volume 122 directly without passing through the first UV transparent gas distribution showerhead 116 to mix with the gas that was previously exposed to UV radiation in the gas volume 130. The mixed gasses in the distribution volume 122 are further exposed to UV radiation through the first UV transparent gas distribution showerhead 116 before flowing through the second UV transparent gas distribution showerhead 124 into a space proximate the substrate support 108. The gas proximate the substrate support 108, and the substrate 110 disposed on the substrate support 108, is further exposed to the UV radiation through the second UV transparent gas distribution showerhead 124. Gases may be exhausted through the opening 136. Purge gases may be provided through the opening 138 in the bottom of the chamber, such that the purge gases flow around the substrate support 108, effectively preventing intrusion of process gases into the space under the substrate support 108.

The first UV transparent gas distribution showerhead 116 includes a plurality of through holes that allow processing gas to flow from the gas volume 130 to the distribution volume 122. The second UV transparent gas distribution showerhead 124 also includes a plurality of through holes that allow processing gas to flow from the distribution volume 122 into the processing space proximate the substrate support 108. The through holes in the first and second UV transparent gas distribution showerheads 116, 124 may be evenly distributed.

In operation, processing gases are provided to the gas volume 130 and the distribution volume 122 and pass through the first and second UV transparent gas distribution showerheads 116, 124 to perform a material operation on the substrate 110 disposed on the substrate support 108. Residues of the processing gases impinge on various chamber surfaces and components, such as the window 114 or either side of the first and second UV transparent gas distribution showerheads 116, 124. In one embodiment, the residues comprise silicon carbide oxide (SiCO), silicon oxide or aluminum fluoride (AlF₃). SiCO residues, as discussed herewithin, refer to any residues that contain silicon, carbon and oxide. The proportions of silicon, carbon and oxygen in the SiCO may vary, as shown further below in reference to Table 1.

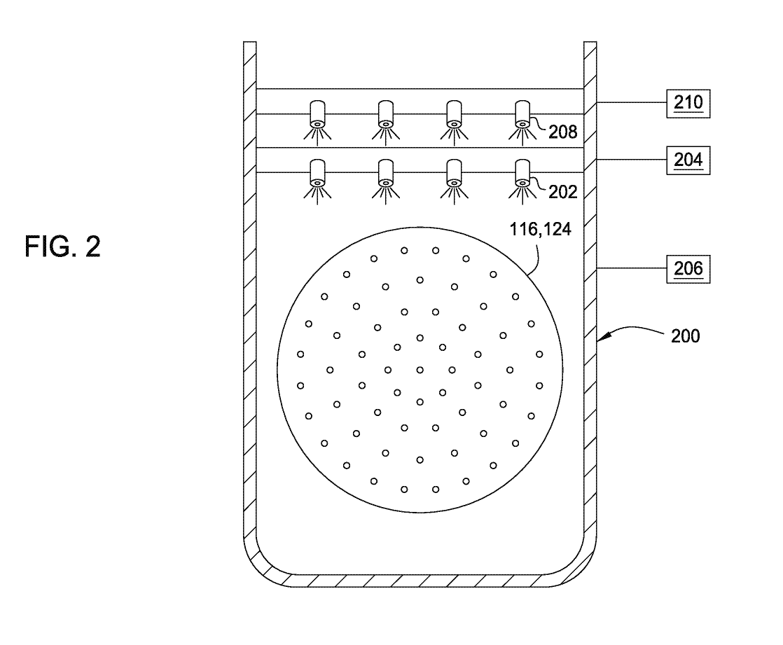

FIG. 2 is a schematic sectional view of a cleaning container 200. The cleaning container 200 is configured to wet clean residues from a chamber component comprising quartz or silicon oxide components, such as the UV transparent gas distribution showerheads 116, 124. The cleaning container 200 includes a plurality of cleaning solution nozzles 202 coupled to a cleaning solution source 204 to provide cleaning solution to the container 200. The cleaning container 200 may be also be coupled to an ultrasonic power source 206 by a transducer (not shown) to provide ultrasonic power to the cleaning solution in the container 200. Optionally, the container 200 may also include a plurality of water nozzles 208 coupled to a water or deionized water source 210 to provide a water or deionized water wash or spray to the UV transparent gas distribution showerheads 116, 124 upon exiting the container 200.

In one embodiment, a method 300 of removing residues from a chamber component of processing chamber 100, such as the UV transparent gas distribution showerheads 116, 124, is provided. It should be noted that the sequence of the method discussed below is not intended to be limiting as to the scope of the invention described herein, since one or more elements of the sequence may be added, deleted and/or reordered without deviating from the basic scope of the invention.

At block 302, the chamber component is soaked in a cleaning solution in the cleaning container 200. In one embodiment, the cleaning solution includes ammonium fluoride (NH₄F) and hydrofluoric acid (HF). In one embodiment, the cleaning solution also includes water (H₂O) in addition to the NH₄F and HF. The cleaning solution may have an NH₄F acid concentration (wt %) between about 5% by weight and about 60% by weight, for example between about 30% by weight to about 40% by weight, or for example 36% by weight. The cleaning solution may have a HF acid concentration between about 0.5% by weight to about 10% by weight, for example about 3% by weight to about 10% by weight, or for example 5% by weight. In another embodiment, the NH₄F to HF ratio by weight may be about 7:1. Additionally, the chamber component is soaked in the cleaning solution between about 1 minute to about 60 minutes, for example between about 3 minutes to about 10 minutes, or for about 3 minutes. The soaking time may be a function of the thickness of the residue formed on the chamber component.

At block 304, an ultrasonic power may also be applied to the container 200 to provide ultrasonic energy to the cleaning solution during soaking. In one embodiment, the ultrasonic power is applied at a power of about 45 W/gallon of cleaning solution to about 55 W/gallon of cleaning solution, for example about 50 W/gallon of cleaning solution, and at a frequency of about 35 kHz to about 45 kHz, for example 40 kHz.

At block 306, the chamber component is removed from the container 200 and may optionally be washed or sprayed with water or deionized water to remove any residual cleaning solution. At block 308, the chamber component may be mechanically polished by a grinder, sander or other suitable polishing tool to provide a smooth surface morphology. Advantageously, the chamber component now has a profile and surface morphology of an unused chamber component.

To provide a better understanding of the foregoing discussion, the following non-limiting example of cleaning conditions is offered. Although the example may be directed to specific embodiments, the example should not be interpreted as limiting the invention in any specific respect.

### EXAMPLES

Gas distribution showerheads fabricated from quartz and having silicon carbide oxide (SiCO) residue formed thereon were analyzed using secondary electron microscopy (SEM) to provide photographs of the thickness of the SiCO residue. Energy-dispersive X-ray spectroscopy (EDX) and X-ray photoelectron spectroscopy (XPS) were used to quantify the elemental composition of SiCO residue. The composition is provided in Table 1 below:

TABLE 1

| | Elemental Composition in atomic percent (at %) | | | |
|---|---|---|---|---|
| | Carbon | Oxygen | Silicon | |
| | (C) | (O) | (Si) | O/Si |
| EDX Analysis | | | | |
| First Showerhead | 34.88 | 50.53 | 14.59 | 3.46 |
| Center | | | | |
| First Showerhead | 11.58 | 73.86 | 14.59 | 5.07 |
| Middle | | | | |
| First Showerhead | 28.18 | 66.06 | 5.76 | 11.47 |
| Edge | | | | |
| Second Showerhead | 8.54 | 75.27 | 16.20 | 4.65 |
| Middle | | | | |
| XPS Analysis | | | | |
| First Showerhead | 18.40 | 56.20 | 24.90 | 2.26 |
| Center | | | | |
| First Showerhead | 39.40 | 39.20 | 18.80 | 2.09 |
| Edge | | | | |
| Second Showerhead | 15.10 | 57.50 | 27.00 | 2.13 |
| Middle | | | | |

Bonding state analysis by XPS revealed that the SiCO residue primarily comprises of SiO₄ and SiO₃C structural units. The gas distribution showerhead having the SiCO residue was then soaked in a solution comprising NH₄F, HF and H₂O, because the structural unit of SiO₄ in SiCO residue is the same as that in quartz glass. The solution comprising NH₄F and HF, includes a NH₄HF₂ group and NH₄F. When the quartz showerhead was soaked in the solution comprising NH₄F and HF, the following chemical reaction resulted:

3NH₄HF₂+[SiO₄]→(NH₄)₂(SiF₆)+NH₄OH+H₂O

6NH₄F+[SiO₄]→(NH₄)₂(SiF₆)+2NH₄OH+2NH₃

The resulting chemical reaction yielded a moderate reaction at the SiO₄ sites in the SiCO depositions and meanwhile the surrounding SiO₃C sites were removed to uniformly remove the SiCO residue from the quartz showerhead surfaces. Even after long periods of soaking, the SEM profiles revealed a quartz surface without “scratches” (i.e. over-clean or over-etching indicators).

The surface morphology of the quartz showerhead was observed with respect to the cleaning solution composition and acid weight concentration, a soak time, and an ultrasonic power and frequency applied to the cleaning solution. The various cleaning conditions in Experiments A-J for Showerheads A-J, are summarized in Table 2 below:

TABLE 2

| | | Cleaning Condition Parameters | | |
|---|---|---|---|---|
| | | | | Ultrasonic |
| | | | | Power |
| Experi- | | | | (watt/gallon) |
| ment/ | Cleaning | Acid Weight | Soak | and |
| Show- | Solution | Concentration | Time | Frequency |
| erhead | Composition | (wt %) | (minutes) | (kHz) |
| A | HF | 0.50% | 10 | 50 W/gallon, |
| | | | | 40 kHz |
| B | HF | 5% | 5 | 50 W/gallon, |
| | | | | 40 kHz |
| C | HF | 3% | 10 | 50 W/gallon, |
| | | | | 40 kHz |
| D | HNO₃ | 3% | 10 | 50 W/gallon, |
| | | | | 40 kHz |
| E | HNO₃ | 10% | 40 | 50 W/gallon, |
| | | | | 40 kHz |
| F | HF + HNO₃ | N/A | 10 | 50 W/gallon, |
| | | | | 40 kHz |
| G | HF + HNO₃ | N/A | 30 | 50 W/gallon, |
| | | | | 40 kHz |
| H | NH₄F + HF | 36% NH₄F + | 1-10 | 50 W/gallon, |
| | | 15% HF | | 40 kHz |
| | | (9 parts by | | |
| | | weight of 40% | | |
| | | NH₄F, and 3 | | |
| | | parts by | | |
| | | weight of 49% | | |
| | | HF) | | |
| I | NH₄F | 40% NH₄F | 10 | 50 W/gallon, |
| | | | | 40 kHz |
| J | NH₄F + HF | 36% NH₄F + | 3 | 50 W/gallon, |
| | | 5% HF | | 40 kHz |
| | | (9 parts by | | |
| | | weight of 40% | | |
| | | NH₄F, and 1 | | |
| | | part by weight | | |
| | | of 49% HF) | | |

Subsequent visual inspection, SEM morphology, EDX analysis and surface profile inspections of the Showerheads A-J were compared to the elemental composition of the SiCO residue provided in Table 1. The analysis revealed that: (i) Experiments A and D resulted in no SiCO removal from the Showerheads A and D; (ii) Experiments B, E and F resulted in enough SiCO residue remaining on Showerheads B, E and F to not be considered clean; (iii) Experiments C and G resulted in over-cleaning and scratch features on Showerheads C and G; (iv) Experiment H resulted in a clean Showerhead H, however there were a few scratches features in areas of high deposition (for example, areas found on showerhead 116); and (v) Experiment I resulted in no change on the surface of Showerhead I at all. Advantageously, Experiment J resulted in a clean surface removing all SiCO residue from Showerhead J with no scratch features. The particular 36% by weight NH₄F+5% by weight HF composition with SiCO residue beneficially provides no free HF groups in the solution, which would normally over-clean or scratch a quartz surface. In one embodiment, where the aqueous cleaning solution consists of NH₄F and HF, 9 parts by weight of NH₄F at 40% acid weight concentration and 1 part by weight of HF at 49% acid weight concentration, provides the same results as experienced in Experiment J on Showerhead J.

Unless otherwise indicated, all numbers expressing quantities of properties, reaction conditions, used in the specification and claims are to be understood as approximations. These approximations are based on the desired properties sought to be obtained by the invention, and the error of measurement, and should at least be construed in light of the number of reported significant digits and by applying ordinary rounding techniques. Further, any of the quantities expressed herein, including acid weight concentration, time, power, frequency, may be further optimized to achieve the desired cleaning and performance.

Embodiments of the invention improve the cleanliness of the surface of chamber components, such as quartz showerheads. Particularly, a cleaning solution of NH₄F and HF effectively cleans the SiCO residue found on quartz chamber components. Therefore, the UV source efficiency is enhanced as the showerheads increase the UV transmittance.

While the foregoing is directed to embodiments of the invention, other and further embodiments of the invention may be devised without departing from the basic scope thereat, and the scope thereof is determined by the claims that follow.

1. A method for cleaning an ultraviolet (UV) processing chamber component, comprising:
soaking the chamber component having a SiCO residue formed thereon in a cleaning solution comprising about 5% by weight to about 60% by weight of NH₄F and about 0.5% by weight to about 10% by weight of HF for about 1 to about 10 minutes; and
polishing the chamber component.

2. The method of claim 1, wherein the cleaning solution further comprises water.

3. The method of claim 1, wherein the cleaning solution comprises about 30% by weight to about 40% by weight of NH₄F.

4. The method of claim 3, wherein the cleaning solution comprises about 3% by weight to about 10% by weight of HF.

5. The method of claim 1, wherein the chamber component is soaked for about 3 to about 10 minutes.

6. The method of claim 1, wherein the method further comprises:
applying an ultrasonic power to the cleaning solution.

7. The method of claim 6, wherein the ultrasonic power is applied at a power of about 45 W/gallon of the cleaning solution to about 55 W/gallon of the cleaning solution, at a frequency of about 35 kHz to about 45 kHz.

8. The method of claim 7, wherein the wherein the ultrasonic power is applied at a power of about 50 W/gallon of the cleaning solution, at a frequency of about 40 kHz.

9. The method of claim 1, wherein the chamber component is fabricated from quartz.

10. The method of claim 9, wherein the chamber component is a gas distribution showerhead.

11. A method of cleaning a processing chamber component fabricated from quartz comprising:
soaking the chamber component having a SiCO residue formed thereon in a cleaning solution comprising about 36% by weight of NH₄F and about 5% by weight of HF for about 3 minutes;
applying an ultrasonic power to the cleaning solution; and
mechanically polishing the chamber component.

12. The method of claim 11, wherein the cleaning solution further comprises water.

13. The method of claim 11, wherein the ultrasonic power is applied at a power of about 45 W/gallon of the cleaning solution to about 55 W/gallon of the cleaning solution, at a frequency of about 35 kHz to about 45 kHz.

14. The method of claim 13, wherein the wherein the ultrasonic power is applied at a power of about 50 W/gallon of the cleaning solution, at a frequency of about 40 kHz.

15. The method of claim 14, wherein the chamber component is a gas distribution showerhead.
